(19) United States
(12) Patent Application Publication
(10) Pub. No.: US 2008/0142489 A1
(43) Pub. Date: Jun. 19, 2008

(54) Apparatus for covering contoured surface of metal workpiece with inert gas

(76) Inventors: Charles S. Willis, Enumclaw, WA (US); Gregory L. Ramsey, Seabeck, WA (US); Jeff D. Will, Renton, WA (US)

Correspondence Address: Dennis M. Flaherty, Esq.;Ostrager Chong Flaherty & Broitman P.C., Suite 825, 250 Park Avenue, New York, NY, 10177-0899, US

(21) Appl. No.: 11/642,289

(22) Filed: Dec. 19, 2006

(51) Int. Cl. B23K 37/00

(52) U.S. Cl. 219/74

(57) ABSTRACT

A self-adjusting trailing shield for maintaining a volume of inert gas over a portion of a metal workpiece being subjected to a metal processing operation. The shield has segmented side walls, each segment being independently vertically displaceable as the shield is carried in a horizontal plane across a contoured surface of a workpiece. Each segment will be forced upward when it contacts and slides up a rising surface portion of the workpiece. Each segment is coupled to a respective spring that restores each deflected segment to its original, i.e., fully extended, position as the segment slides down a falling surface. The result is a continual reconfiguration of the segmented side walls that reduces the amount of inert gas escaping from the cover space during travel of the shield, as compared to a shield having rigid, not segmented, side walls.

### TECHNICAL FIELD

The present invention relates generally to a shield for use in processing reactive metals in an inert gas environment. More particularly, this invention is directed to a shield which can be used in conjunction with operations utilizing high-power-density processes such as lasers and out-of-vacuum electron beams or arc-assisted processes such a GMAW, GTAW and plasma welding and/or cladding systems.

### BACKGROUND

In most welding, surfacing and cladding operations wherein sufficient heat is applied for melting metal alloys, it is essential to shield the thermally excited regions with specially formulated gases. Reactive metals (i.e., titanium, zirconium, and hafnium) at elevated temperatures have high solubilities for oxygen, nitrogen, and hydrogen. The dissolution of relatively small amounts of these gases into the metal significantly affects the metal's physical properties. For example, the dissolution of oxygen and nitrogen significantly increase hardness while the dissolution of hydrogen reduces toughness and increases notch sensitivity.

Oxygen, nitrogen, and hydrogen are all present in the atmosphere. Therefore, when welding reactive metals it is important to shield from the atmosphere that portion of the reactive metal that would be at elevated temperatures (i.e., molten weld pool, hot solidified weld metal, and adjacent heat-affected zone). The shielding is normally accomplished by surrounding the area to be protected by a nonreactive gas such as argon or helium.

In the case of arc processes, proper selection of shielding gas based on its ionization potential, density, thermal conductivity and chemical reactivity with the molten and solidified alloys, and controlled introduction of the selected gas about the welding region, that is, the arc and molten pool, ensure stable arc behavior, and volumetrically sound and dimensionally consistent deposits with proper composition. This minimizes alloy loss due to oxidation. Similarly, many laser-assisted welding, surfacing and cladding operations are affected by the gas shielding quality.

The shielding of the molten weld pool is conventionally provided by a torch shield. The torch shield is disposed at the terminus of the welding torch and consists of a cup open at one end through which an electrode protrudes. This shield advances in the direction of the welding and therefore does not shield either the solidified weld metal or the adjacent heat-affected zone. In order to protect this area, a trailing shield is employed. Many conventional trailing shields consist of a rigid housing that is mounted to the welding torch and configured to provide effective shielding to a predetermined surface configuration.

Various problems exist with rigidly constructed trailing shields. For example, if the surface configuration changes or another workpiece of different configuration is to be welded, the trailing shield would have to be replaced with one adapted to the particular surface configuration. Similarly, if no trailing shield is available for a particular surface configuration, less than adequate shielding will be provided.

U.S. Pat. No. 4,599,505 discloses a trailing shield for providing nonreactive gas shielding to a welding operation, the shield comprising a housing formed of interlocking transverse segments and purportedly “capable of flexibly covering weld surfaces having varying configurations” (col. 1, lines 34-37).

There is a need for a shield capable of maintaining an inert gas envelope around the top of a workpiece having a contour with sharp turns, such as airframe components.

### SUMMARY OF THE INVENTION

The present invention is a self-adjusting trailing shield for maintaining a volume of inert gas over a portion of a metal workpiece being subjected to a metal processing operation. The shield has a pair of side walls, each side wall comprising a fixed portion and a segmented portion, each segment being independently vertically displaceable relative to the fixed portion as the shield is carried in a horizontal plane across a contoured surface of a workpiece. Each segment will be forced upward when it contacts and slides up a rising surface portion of the workpiece. Each segment is coupled to a respective compression spring that restores each deflected segment to its original, i.e., fully extended, position as the segment slides down a falling surface. The result is a continual reconfiguration of the segmented portions of the side walls that reduces the amount of inert gas escaping from the cover space during travel of the shield, as compared to a shield having rigid side walls without vertically displaceable segments.

One aspect of the invention is a shielding apparatus for metal processing operations comprising: a base comprising an opening and first and second sides; a first plurality of segments arranged side by side in a row along the first side of the base; and a second plurality of segments arranged side by side in a row along the second side of the base, wherein each of the segments is independently displaceable in a direction that is generally transverse to the base and between extended and retracted positions, the segments and the base forming a tunnel when the segments are all in their extended positions.

Another aspect of the invention is an apparatus for metal processing operations comprising: means for directing energy toward a metal workpiece to raise the temperature of a portion of the surface of the workpiece; a shielding apparatus attached to the energy directing means; and means for supplying pressurized inert gas to the shielding apparatus, wherein the shielding apparatus comprises: a base attached to the energy directing means; a first plurality of segments arranged side by side in a row along a first side of the base; and a second plurality of segments arranged side by side in a row along a second side of the base, wherein each of the segments is independently displaceable in a direction that is generally transverse to the base and between extended and retracted positions, the segments and the base forming a tunnel when the segments are all in their extended positions, the tunnel being in fluid communication with the inert gas supplying means.

A further aspect of the invention is a shielding apparatus for metal processing operations comprising: a base comprising an opening; a plurality of segments arranged side by side to form a barrier, wherein each of the segments is independently displaceable in a direction that is generally transverse to the base and between extended and retracted positions; a multiplicity of guiding means supported by the base, each of the guiding means guiding a respective one of the segments along the direction of displacement; and a multiplicity of springs supported by the base, each of the springs urging a respective segment toward its extended position.

Yet another aspect of the invention is a method of manufacturing an aircraft component having a contoured surface, comprising the following steps: subjecting portions of a workpiece to a metal processing operation; moving a gas shield having an interior space over portions of the workpiece to be subjected to the metal processing operation, the interior space being bounded in part by a plurality of vertically displaceable wall segments; supplying inert gas into the interior space of the gas shield during movement of the gas shield; and maintaining a volume of inert gas over any portion of the workpiece to be subjected to the metal processing operation, wherein said maintaining step comprises the step of displacing the wall segments vertically to compensate for changing elevation of the surface of those portions of the workpiece to be subjected to the metal processing operation.

Other aspects of the invention are disclosed and claimed below.

### BRIEF DESCRIPTION OF THE DRAWINGS

FIG. 1 is a schematic showing a side view of a gas shield in accordance with one embodiment of the invention.

FIG. 2 is a schematic showing an isometric view of the gas shield of FIG. 1 in an upside-down position.

FIG. 3 is a schematic showing an isometric view of the gas shield of FIG. 1 from a vantage point forward of the leading wall of the shield.

FIG. 4 is a schematic showing a front view of a subassembly of the gas shield in accordance with the disclosed embodiments of the invention. Only one of multiple vertically displaceable gas shield slide segments is shown mounted to a side plate.

FIG. 5 is a schematic showing an end view of the subassembly depicted in FIG. 4 without the vertically displaceable gas shield slide segment.

FIG. 6 is a schematic showing a cross-sectional view of a side wall of the shield depicted in FIG. 1, the section line being taken along line 6-6 seen in FIG. 1.

FIG. 7 is a schematic showing a side view, on an enlarged scale, of a leading portion of the shield as seen in FIG. 1, which leading portion incorporates a vertically displaceable subassembly that includes a front gas shield slide door and a roller bearing designed to roll on a surface of a workpiece.

FIG. 8 is a schematic showing a side view of portions of a trailing gas shield attached to a laser welding head. For simplicity, neither front nor rear gas shield slide doors are shown.

Reference will now be made to the drawings in which similar segments in different drawings bear the same reference numerals.

### DETAILED DESCRIPTION OF THE INVENTION

The present invention provides a shield that can be used to cover reactive metal alloys with inert gas during welding, surfacing or cladding operations. These operations can be performed with either high-power-density processes, such as lasers and out-of-vacuum electron beams, arc-assisted processes, such as GMAW (MIG) or GTAW (TIG), or plasma welding and/or cladding systems. The specific embodiment disclosed in detail herein is designed for use with a laser welding apparatus. However, this implementation of the shield is for illustrative purposes only and those skilled in the art readily appreciate that this invention can be utilized in conjunction with the other types of processes as indicated above. Moreover, many specific details of certain embodiments of the invention are set forth in the following description and shown in the drawings in order to provide a thorough understanding of these embodiments. One skilled in the art, however, will understand that the present invention may have additional embodiments, and that the invention may be practiced without several of the features described in detail below.

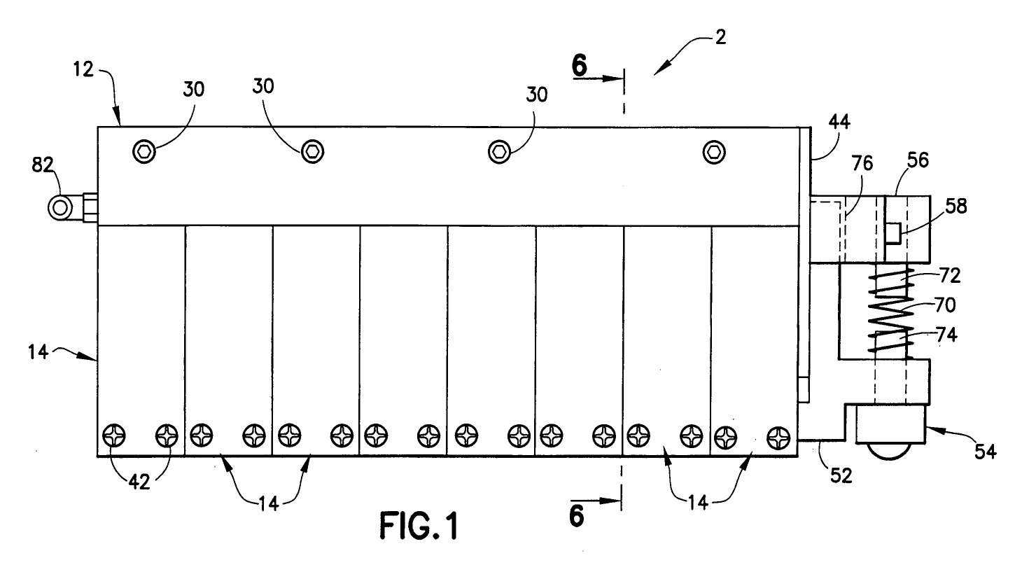

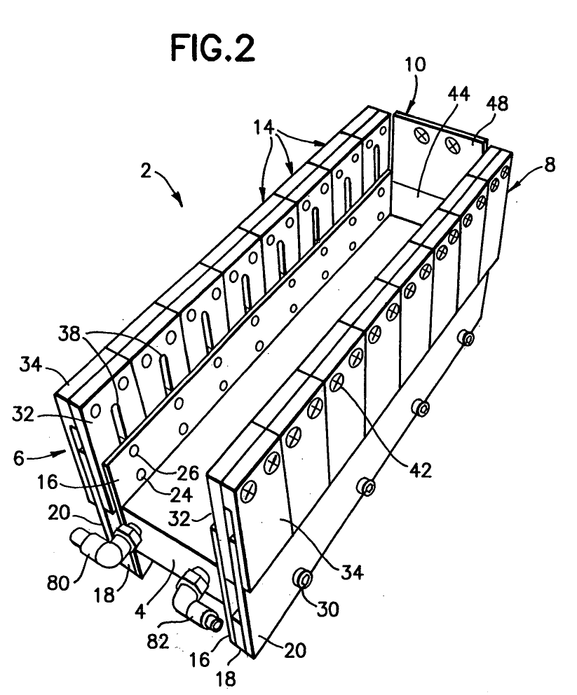

FIG. 1 is a schematic showing a side view of a trailing shield 2 in accordance with one embodiment of the invention. FIG. 2 shows an isometric view of the same trailing shield, but in an upside-down position. In this specific embodiment, the shield 2 has a ceiling 4, opposing side walls 6 and 8, and a leading wall 10, portions of which serve as gas barriers forming a tunnel that is open at the trailing end, as best seen in FIG. 2.

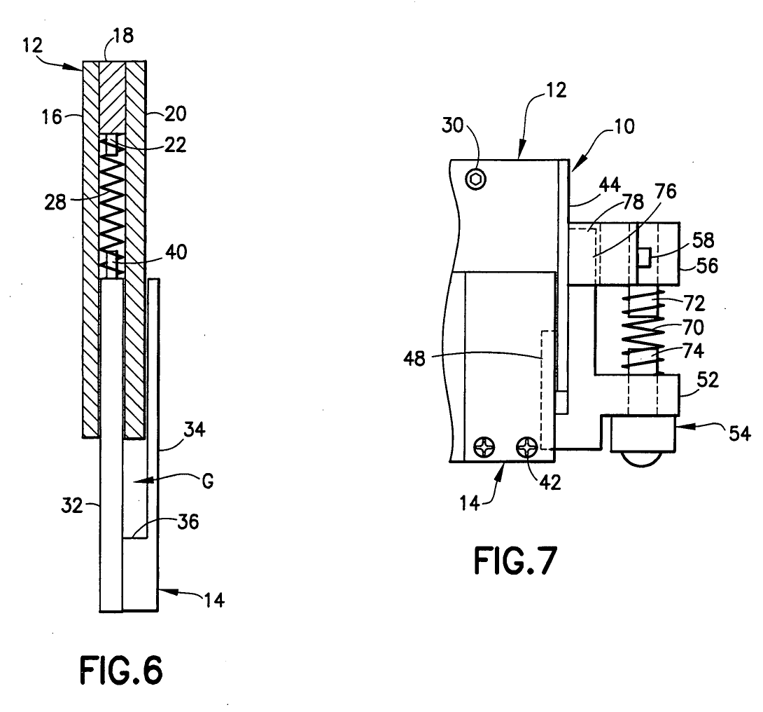

Still referring to FIG. 2, the ceiling is formed by a base 4 in the shape of a beam with six generally rectangular faces; the side wall 6 is formed by a first subassembly attached to one side of the base 4; the side wall 8 is formed by a second subassembly attached to the other side of the base 4; and the leading wall 10 is formed by a third subassembly attached to the leading end of the base 4. The first and second subassemblies have similar constructions, which construction is best seen in FIG. 6 (to be described in detail later). The side walls 6 and 8 have the same length and are substantially mutually parallel.

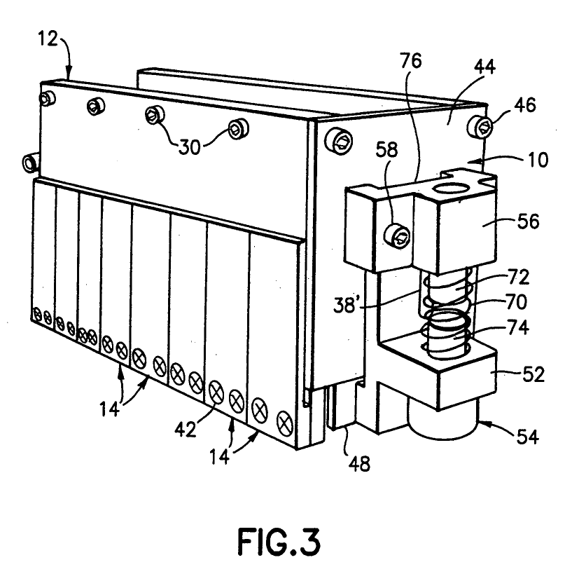

In an alternative embodiment (not shown), the shield can also be provided with a trailing wall, portions of which would form a gas barrier at the trailing end of the tunnel. That trailing wall may have a structure substantially similar to that of the leading wall (described in detail later with reference to FIGS. 3 and 7) and would be attached to the trailing end of the base.

The base 4 is provided with a U-shaped cooling channel (not shown in FIG. 2). Both legs of the U-shaped cooling channel terminate at respective ports formed in the trailing end face of base 4. A first port is connected to a first coupling 80 that couples the first port to a pipe, hose or other conduit for cooling fluid. The other port is connected to a second coupling 82 that couples that port to another pipe, hose or other conduit for cooling fluid. Cooling fluid enters the U-shaped cooling channel via coupling 80 and exits via coupling 82. The circulating fluid carries away heat from base 4 during the metal processing operation.

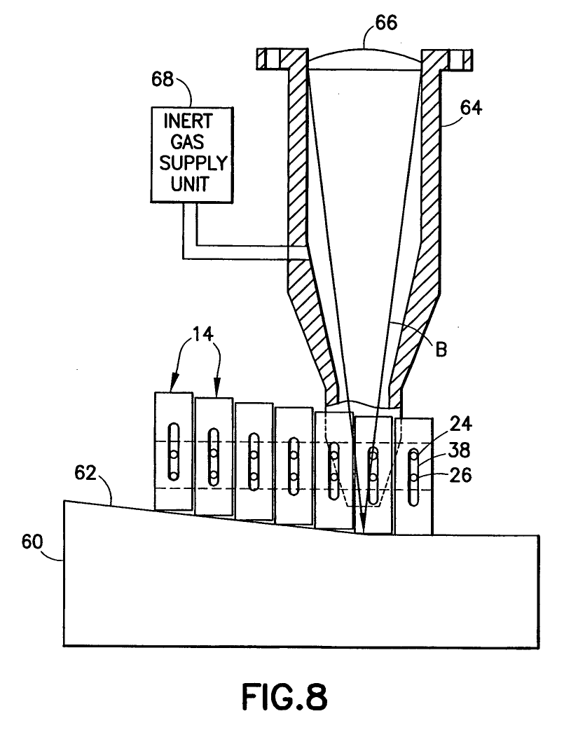

Referring now to FIGS. 1 and 6, the basic structure of each side wall 6, 8 will now be described. FIG. 6 is a sectional view taken along section line 6-6 indicated in FIG. 1. Each side wall comprises a fixed side wall subassembly 12, which is attached to the base 4 by means of a plurality of fasteners (not shown in FIG. 1), and a plurality of generally rectangular, vertically displaceable side wall segments 14 (hereinafter “gas shield slide segments”). The section line is located such that the fixed side wall assembly 12 is shown in section in FIG. 6, but the gas shield slide segment 14 is not. Each gas shield slide segment 14 is vertically displaceable relative to the fixed side wall subassembly 12 supporting it. More specifically, each gas shield slide segment 14 is independently vertically displaceable relative to the fixed portion as the trailing shield 2 is carried in a horizontal plane across a contoured surface of a workpiece. When in contact with the workpiece surface, each slide segment 14 will be forced upward as it slides up a rising surface portion of the workpiece (as shown in FIG. 8, to be described in detail later). After each rise, a deflected segment will be urged to return to its starting position by a compression spring 28 (see FIG. 6), which is compressed during upward gas shield slide segment displacement. Optionally, each gas shield slide segment 14 may be provided with a roller bearing for rolling contact with the workpiece surface.

As seen in FIG. 6, each fixed side wall subassembly 12 comprises a side plate 16, a spacer 18, and a cover plate 20. As best seen in the end view of FIG. 5, the spacer 18 is attached to a topmost portion of the side plate 16. As seen in FIG. 6, the cover plate 20 is thereafter attached to the spacer 18 and side plate 16. The side plate 16, spacer 18, and cover plate 20 may be fastened together by means of a plurality of fasteners 30, seen, e.g., in FIG. 1. The resulting subassembly has an inverted U-shape when viewed in section (see FIG. 6). The spacer 18 maintains a constant gap between side plate 16 and cover plate 20, which gap will receive a portion of each vertically displaceable gas shield slide segment 14, which, as seen in FIG. 6, also has a U-shape.

Still referring to FIG. 6, each gas shield slide segment 14 is a respective subassembly comprising a side plate 32 and a cover lid 34. The cover lid 34 is an integral structure having a flange 36 for maintaining a constant gap G between the side plate 32 and the wall of the cover lid 34. The gap G receives a portion of the cover plate 20 of the fixed side wall subassembly 12, thereby effectively interleaving the U-shaped subassemblies 12 and 14. For each gas shield slide segment 14, the side plate 32 and the cover lid 34 are affixed to each other by means of a pair of fasteners 42 (see FIGS. 1-3 and 7). As seen in FIG. 2, the side plate 32 of each gas shield slide segment 14 has a vertical slot 38 while the corresponding cover lids 34 are not slotted.

The interleaved U-shaped subassemblies 12 and 14 are coupled in a manner that allows each gas shield slide segment 14 to displace vertically (along the line of slot 38) relative to the fixed side wall assembly 12. As seen in FIG. 8, the feet 14 displace vertically independently in response to changes in the contour of the abutting surface 62 of the workpiece 60 being welded.

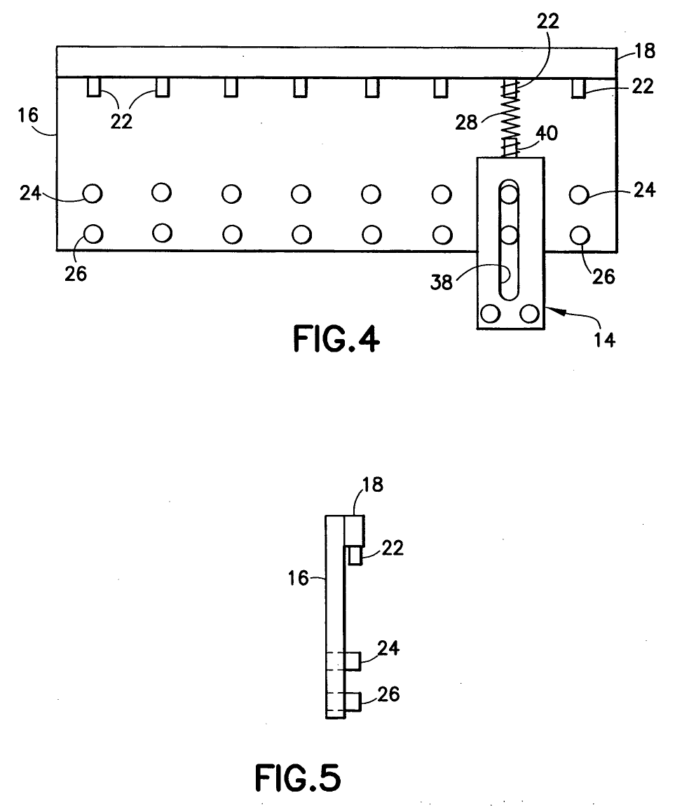

Referring to FIGS. 4 and 5 (which respectively show front and end views of a fixed side wall assembly with the cover plate removed), each gas shield slide segment 14 is guided to displace vertically by the interference of a respective pair of segment guide pins 24 and 26 with vertical slot 38 of the gas shield slide segment. Each segment guide pin 24, 26 may have a threaded end and an unthreaded end, the former being screwed into a respective threaded bore (not shown) in the side plate 16 (see FIG. 5). Alternatively, each segment guide pin 24, 26 could be unthreaded on both ends, with one end being press fit into a respective unthreaded bore in the side plate 16. The upper limit position of each gas shield slide segment 14 is determined by abutment of the bottom end of slot 38 against guide pin 26; likewise the lower limit position of each gas shield slide segment 14 is determined by abutment of the top end of slot 38 against guide pin 24.

As shown in FIG. 4, each gas shield slide segment 14 is urged downward, toward its lower limit position, by means of a respective compression spring 28 (only one of which is shown) having ends respectively seated on spring placement pins 22 and 40. The spacer 18 of each sidewall supports a plurality of spring placement pins 22, one for each gas shield slide segment 14. The spring placement pins 22 are fixed to the spacer 18 at regular spaced intervals approximately equal to the width of a gas shield slide segment 14. Each spring placement pin 22 may have a threaded end and an unthreaded end, the former being screwed into a respective threaded bore (not shown) in the spacer 18. Alternatively, the pins 22 could be unthreaded on both ends, with one end being press fit into an unthreaded bore in the spacer. Each gas shield slide segment 14 supports a respective spring placement pin 40 (only one of which is shown in FIG. 4), which may be screwed into a threaded bore or press fit into an unthreaded bore in the top of the side plate 32 of the gas shield slide segment 14, as best seen in FIG. 6.

As the contoured surface of the workpiece exerts a reaction force on the contacting portion of a gas shield slide segment 14, the corresponding segment guide pins 24 and 26 interact with the sides of slot 38 of that gas shield slide segment to block horizontal displacement of the latter relative to the fixed side plate 16, while allowing the gas shield slide segment to displace vertically upward toward its upper limit position. During this upward vertical movement, the associated spring 28 is compressed to provide a spring force that urges the gas shield slide segment 14 toward its lower limit position.

In accordance with the disclosed embodiment, the leading wall 10 (see FIGS. 3 and 7) comprises a fixed front plate 44 and a vertically displaceable front gas shield slide door. The fixed front plate 44 is fastened to the side wall assemblies by means of a pair of fasteners 46. The front gas shield slide door comprises a cover plate 48 and a support fixture 52. The support fixture 52 supports a roller bearing 54 that contacts and rolls along the surface of the workpiece. As the leading end of the trailing shield moves across a rising workpiece surface, the roller of roller bearing 54 rolls along that rising surface and the front gas shield slide door (including support fixture 52 and cover plate 48 attached thereto) is deflected upward.

The support fixture 52 is constrained to displace only vertically by means similar to the pin/slot arrangement previously described. In one implementation, the support fixture 52 has a slot 38′ (see FIG. 3) that is guided and constrained by a pair of guide pins (not shown but similar to segment guide own in FIG. 5) affixed to the front plate 44. As a result, the support fixture 52 is vertically displaceable between upper and lower limit positions determined by abutment of the ends of slot 38′ against the respective guide pins affixed to the front plate 44.

When displaced vertically upward away from its lower limit position, the support fixture 52 is urged downward by the spring force of a compression spring 70 having ends respectively seated on spring placement pins 72 and 74. The spring placement pin 74 is fixed to the support fixture and has roller bearing 54 connected to the end thereof opposite to the end that locates spring 70. The spring placement pin 72 is fixed to a mounting block 56, the latter being in turn affixed to the front plate 44 by means of a pair of fasteners 58. Each spring placement pin 72, 74 may have a threaded end and an unthreaded end, the former being screwed into a respective threaded bore (not shown) in mounting block 56 or support fixture 52. Alternatively, the spring placement pins 72, 74 could be unthreaded on both ends, with one end being press fit into an unthreaded bore in mounting block 56 or support fixture 52.

As seen in FIG. 7, the mounting block 56 has a recess 76 that provides clearance for the upwardly extending portion 78 of the support fixture 52 during vertical displacement thereof. Likewise, a gap between vertical portion 78 and cover plate 48 provides clearance for the bottom portion of fixed front plate 44 during upward vertical displacement of support fixture 52.

A person skilled in the art will readily appreciate that the trailing end of the trailing shield may be provided with gas shielding means similar in construction to the front gas shield slide door shown in FIG. 7. More specifically, a rear gas shield slide door (not shown in the drawings) may be provided that comprises a fixed subassembly similar to that comprising items 44, 56 and 72 seen in FIG. 7 and a vertically displaceable subassembly similar to that comprising items 48, 52, 54 and 74 seen in FIG. 7.

FIG. 8 is a schematic showing a side view of portions of a trailing gas shield attached to a laser welding head 64. For simplicity, neither front nor rear gas shield slide doors are shown. Inert gas is supplied to an interior volume of laser welding head 64 by an inert gas supply unit 68. That inert gas flows through an opening in the bottom of the welding head and into the interior space of the trailing shield. The laser welding head comprises a lens 66 for directing a laser beam toward a junction between two workpieces (only one workpiece 60 being visible in FIG. 8) to be laser welded together. In this example, the workpieces have non-planar top surfaces (only the top surface 62 of workpiece 60 being indicated in FIG. 8). As the laser welding head is moved from left to right in FIG. 8, the slide segments 14 of the trailing shield adjust vertically to the contour of the work surface 62. FIG. 8 shows some of the slide segments at different elevations. At the same time the front and read slide doors (not shown in FIG. 8) adjust vertically as the contour of the work surface changes. The adjustable vertical displacement of the slide segments and slide doors reduces the amount of inert gas that escapes from the interior space of the trailing shield as the latter is moved across a work surface that is not parallel to the plane in which the trailing shield is being moved.

While the invention has been described with reference to certain embodiments, it will be understood by those skilled in the art that various changes may be made and equivalents may be substituted for members thereof without departing from the scope of the invention. In addition, many modifications may be made to adapt a particular situation to the teachings of the invention without departing from the essential scope thereof. Therefore it is intended that the invention not be limited to the particular embodiment disclosed as the best mode contemplated for carrying out this invention, but that the invention will include all embodiments falling within the scope of the appended claims.

As used in the claims, the term “metal” encompasses both pure metals and alloys of two or more metals.

1. A shielding apparatus for metal processing operations comprising:
a base comprising an opening and first and second sides;
a first plurality of segments arranged side by side in a row along said first side of said base; and
a second plurality of segments arranged side by side in a row along said second side of said base,
wherein each of said segments is independently displaceable in a direction that is generally transverse to said base and between extended and retracted positions, said segments and said base forming a tunnel when said segments are all in their extended positions.

2. The shielding apparatus as recited in claim 1, further comprising a multiplicity of springs, each spring urging a respective segment toward its extended position.

3. The shielding apparatus as recited in claim 1, further comprising means for delivering pressurized inert gas to said opening in said base.

4. The shielding apparatus as recited in claim 1, further comprising a leading wall attached to said base and forming a barrier at a leading end of said tunnel.

5. The shielding apparatus as recited in claim 4, further comprising a trailing wall attached to said base and forming a barrier at a trailing end of said tunnel.

6. The shielding apparatus as recited in claim 1, wherein each of said side wall elements comprises a slot that extends in said direction of displacement.

7. The shielding apparatus as recited in claim 6, further comprising a multiplicity of guiding means, each guiding means guiding a respective one of said segments along said direction of displacement and being supported by said base.

8. The shielding apparatus as recited in claim 7, wherein each of said guiding means comprises first and second pins.

9. The shielding apparatus as recited in claim 4, further comprising a support structure displaceably mounted to said leading wall, and a rolling element supported by said support structure so as to contact the workpiece during processing.

10. The shielding apparatus as recited in claim 1, further comprising means for passing a cooling fluid through said base.

11. An apparatus for metal processing operations comprising:
means for directing energy toward a metal workpiece to raise the temperature of a portion of the surface of the workpiece;
a shielding apparatus attached to said energy directing means; and
means for supplying pressurized inert gas to said shielding apparatus,
wherein said shielding apparatus comprises:
a base attached to said energy directing means;
a first plurality of segments arranged side by side in a row along a first side of said base; and
a second plurality of segments arranged side by side in a row along a second side of said base,
wherein each of said segments is independently displaceable in a direction that is generally transverse to said base and between extended and retracted positions, said segments and said base forming a tunnel when said segments are all in their extended positions, said tunnel being in fluid communication with said inert gas supplying means.

12. The apparatus as recited in claim 11, wherein the energy directed by said energy directing means is a laser beam.

13. The apparatus as recited in claim 11, further comprising a multiplicity of springs, each spring urging a respective segment toward its extended position.

14. The apparatus as recited in claim 11, further comprising a leading wall attached to said base and forming a barrier at a leading end of said tunnel.

15. The apparatus as recited in claim 14, further comprising a trailing wall attached to said base and forming a barrier at a trailing end of said tunnel.

16. The apparatus as recited in claim 11, wherein each of said side wall elements comprises a slot that extends in said direction of displacement, further comprising a multiplicity of guiding means, each of said guiding means guiding a respective one of said segments along said direction of displacement and being supported by said base.

17. The apparatus as recited in claim 11, further comprising a support structure displaceably mounted to said leading wall, and a rolling element supported by said support structure so as to contact the workpiece during processing.

18. The apparatus as recited in claim 11, further comprising means for passing a cooling fluid through said base.

19. A shielding apparatus for metal processing operations comprising:
a base comprising an opening;
a plurality of segments arranged side by side to form a barrier,
wherein each of said segments is independently displaceable in a direction that is generally transverse to said base and between extended and retracted positions;
a multiplicity of guiding means supported by said base, each of said guiding means guiding a respective one of said segments along said direction of displacement; and
a multiplicity of springs supported by said base, each of said springs urging a respective segment toward its extended position.

20. The shielding apparatus as recited in claim 19, wherein each of said guiding means comprises first and second pins supported by said base, and each of said segments comprises an inner wall having a slot that extends in said direction of displacement and an outer wall attached to said inner wall, each slot said first and second pins of a respective guiding means projecting therein.

21. A method of manufacturing an aircraft component having a contoured surface, comprising the following steps:
subjecting portions of a workpiece to a metal processing operation;
moving a gas shield having an interior space over portions of the workpiece to be subjected to the metal processing operation, the interior space being bounded in part by a plurality of vertically displaceable wall segments;
supplying inert gas into the interior space of the gas shield during movement of the gas shield; and
maintaining a volume of inert gas over any portion of the workpiece to be subjected to the metal processing operation, wherein said maintaining step comprises the step of displacing the wall segments vertically to compensate for changing elevation of the surface of those portions of the workpiece to be subjected to the metal processing operation.

22. The method as recited in claim 21, wherein the aircraft component is made of titanium.

23. An aircraft component manufactured using the method as recited in claim 21.
